(19) United States
(12) Patent Application Publication
(10) Pub. No.: US 2008/0104506 A1
(43) Pub. Date: May 1, 2008

(54) Method for producing a document summary

(76) Inventor: Atefeh Farzindar, Mount-Royal (CA)

Correspondence Address: Louis Tessier, P.O. Box 54029, Mount-Royal, QC, H3P 3H4, US

(21) Appl. No.: 11/589,142

(22) Filed: Oct. 30, 2006

(51) Int. Cl. G06F 17/00; G06F 7/00

(52) U.S. Cl. 715/254; 707/100

(57) ABSTRACT

A method for producing a document summary from a document. The method includes:

associating with the document a specific category from a set of predetermined categories;

performing a thematic segmentation of the document to produce a segmented document, the segmented document including a plurality of text segments;

associating with each text segment from the plurality of text segments a theme selected from a set of predetermined themes; and

summarizing the segmented document to produce the document summary by processing each text segment from the plurality of text segments to either
select at least one summary textual unit from the text segment, the at least one summary textual unit including at least one word and being a textual unit considered important in summarizing the document; or
extract no textual unit from the text segment.
   The summary textual units are used to form the document summary. The thematic segmentation is dependent on the category to which the document is associated and the summary textual units are selected for each text segment depending on the theme with which the text segment is associated.

### FIELD OF THE INVENTION

The present invention relates generally to the field of automated text processing and is particularly concerned with a method for producing a document summary from a document.

### BACKGROUND OF THE INVENTION

Significant advances made in information processing technologies in the last few decades have led to the production of relatively large quantities of data. Due to the efficiency with which this data may be processed using information technologies, people often expect that this data be used efficiently by professionals working in many fields.

A specific field in which information is produced in large quantities and in which information needs to be adequately classified and reliably accessed is in the legal field. Indeed, legal experts perform relatively difficult legal clerical work which requires accuracy and speed. These legal experts often summarize legal documents, such as judgments, and look for information relevant to specific cases in these summaries. These tasks involve understanding, interpreting, explaining and researching a wide variety of legal documents. A summary of a judgment, as a compressed but hopefully accurate statement of its contents, helps in organizing a large volume of documents and in finding the relevant judgments for a specific case.

For this reason, the judgments are frequently manually summarized by legal experts. However, human time and expertise require to provide manual summaries for legal researches make human-generated summaries relatively expensive. Also, there is always a risk that a legal expert misinterprets a judgment and, therefore, classifies it in a wrong class by mistake or produces an erroneous summary

Because of the relatively large accuracy required in the classification and summarization of judgments, commonly available automated classification and summarization methods are typically not suitable for this task.

Accordingly, there exists a need for an improved insulating panel to a vehicle. It is a general object of the present invention to provide such an improved insulating panel.

### SUMMARY OF THE INVENTION

In a first broad aspect, the invention provides a method for producing a document summary from a document, the document including a plurality of words and being segmentable into a plurality of text segments, each text segment including at least one word, the document being classifiable as belonging to a category selected from a set of predetermined categories and each text segment being classifiable as belonging to a theme selected from a set of predetermined themes. The method includes:
associating with the document a specific category from the set of predetermined categories;
performing a thematic segmentation of the document to produce a segmented document, the segmented document including the plurality of text segments;
associating with each text segment from the plurality of text segments a theme selected from the set of predetermined themes; and
summarizing the segmented document to produce the document summary by processing each text segment from the plurality of text segments to either
select at least one summary textual unit from the text segment, the at least on summary textual unit including at least one of the word, the at least one summary textual unit being a textual unit considered important in summarizing the document; or
extract no textual unit from the text segment;

the summary textual units being used to form the document summary;

The thematic segmentation is dependent on the category to which the document is associated and the summary textual units are selected for each text segment depending on the theme with which the text segment is associated.

These dependencies have a synergetic effect that results in an unexpectedly high accuracy of the document summary.

For more clarity, for the purpose of this document, textual units are words or groups of words that have a specific meaning. For example, in the expression “Second World War”, the combination of the words “second”, “world” and “war” produces an expression that has by itself a specific meaning. In other words, a textual unit relates to a concept and one or more words are used to express this concept. In some embodiments of the invention, some textual units are whole sentences or whole paragraphs, among other possibilities.

Also, in some embodiments of the invention, the document summary includes a summary of the document in the commonly accepted definition of a comprehensive and usually brief recapitulation of the document. However, in alternative embodiments of the invention, the document summary organizes the information contained in the document in any other manner to summarize the document. For example, and non-limitingly, this information may be organized in table form.

Advantageously the proposed method is relatively efficient, relatively fast and relatively reliable in summarizing certain categories of documents such as, for example, and non-limitingly, legal documents and more specifically judgments.

The proposed method is also relatively easily implemented using commonly used programming languages and is of an efficiency such that it is practical to execute this method on currently available computer hardware.

In addition to producing an accurate document summary from the document, the proposed method also allows to classify the judgments into a specific category from the set of predetermined categories. Therefore, classification, which is often paramount into retrieving information in the legal field, is automatically performed by the proposed method without requiring any additional step.

In some embodiments of the invention, the proposed method is able to process documents in more than one language. This is implemented by first doing the summary of the document in the language in which the document is written. Afterwards, the document summary is translated into at least one other language. Subsequently, the document summary may be searched using queries in one of the two languages. Therefore, the proposed method allows to relatively efficiently process documents in many languages, such as occurs in jurisdictions for which there is more than one official language.

In a variant, the document is associated with the specific category using statistical methods, heuristic methods, or a combination of both heuristic and statistical methods.

In some embodiments of the invention, a thematic segmentation is performed paragraph by paragraph in the document. However, in alternative embodiments of the invention, the thematic segmentation if performed in any other suitable manner.

In a variant, the thematic segmentation is performed by using statistical methods, heuristic methods or a combination of statistical and heuristic methods, among other possibilities.

By using a priori knowledge concerning the structure of the document, which is embedded into the statistical and heuristic methods used in categorizing, segmenting and summarizing the document, relatively complex documents may be relatively easily and accurately classified and summarized.

In the proposed method, the segmentation is dependent upon the category in which the document is classified. Also, the extraction of significant sentences or portion of sentences from the document to produce a document summary is dependent on the theme associated with each text segment. Therefore, prior to being summarized, the document is processed to establish a context in which the summarization occurs, which improves the accuracy of the summary document. This manner of organizing the segmentation and summarization of the document allows to produce relatively good summaries without human intervention.

In another broad aspect, the invention provides a computer readable storage medium containing a program element for execution by a computing device, the program element being able to produce a document summary from a document.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

An embodiment of the present invention will now be disclosed, by way of example, in reference to the following drawings in which:

FIG. 1, in a schematic view, illustrates a computing device for executing a program element implementing a method for producing a document summary from a document in accordance with an embodiment of the present invention;

FIG. 2, in a schematic view, illustrates an example of a structure of a document summarizable by the method executable onto the computing device of FIG. 1;

FIG. 3, in a schematic view, illustrates a method for producing a document summary from a document, the document being shown in FIG. 2 and the method being executable by a program element running on the computer of FIG. 1; and

FIG. 4, in a schematic view, illustrates the program element implementing the method of FIG. 3, the program element being executable by the computer of FIG. 1.

### DETAILED DESCRIPTION

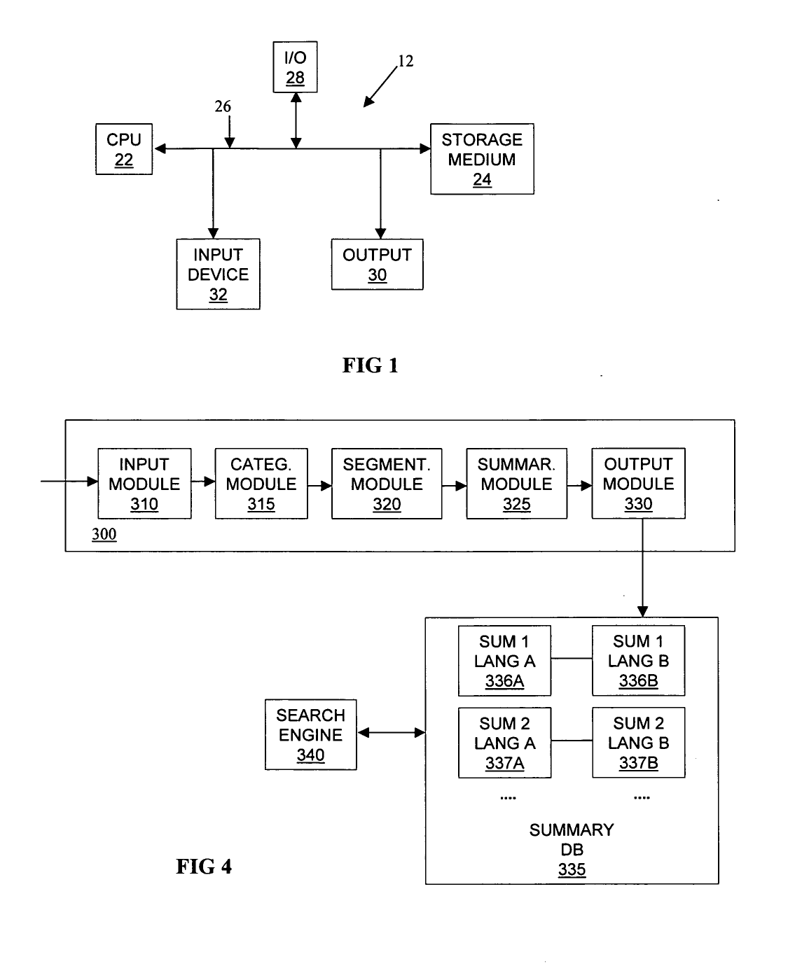

FIG. 1 is a block diagram of an apparatus for producing a document summary from a document in the form of a computing device 12. The computing device 12 includes a Central Processing Unit (CPU) 22 connected to a storage medium 24 over a data bus 26. Although the storage medium 24 is shown as a single block, it may include a plurality of separate components, such as a floppy disk drive, a fixed disk, a tape drive and a Random Access Memory (RAM), among others. The computing device 12 also includes an Input/Output (I/O) interface 28 that connects to the data bus 26. The computing device 12 communicates with outside entities through the I/O interface 28. In a non-limiting example of implementation, the I/O interface 28 is a network interface.

The computing device 12 also includes an output device 30 to communicate information to a user. In the example shown, the output device 30 includes a display. Optionally, the output device 30 includes a printer or a loudspeaker, among other suitable output device components. The computing device 12 further includes an input device 32 through which the user may input data or control the operation of a program element executed by the CPU 22. The input device 32 may include, for example, any one or a combination of the following: keyboard, pointing device, touch sensitive surface or speech recognition unit, among others.

When the computing device 12 is in use, the storage medium 24 holds a program element 300 (seen in FIG. 4) executed by the CPU 22, the program element 300 implementing a method for producing a document summary from a document.

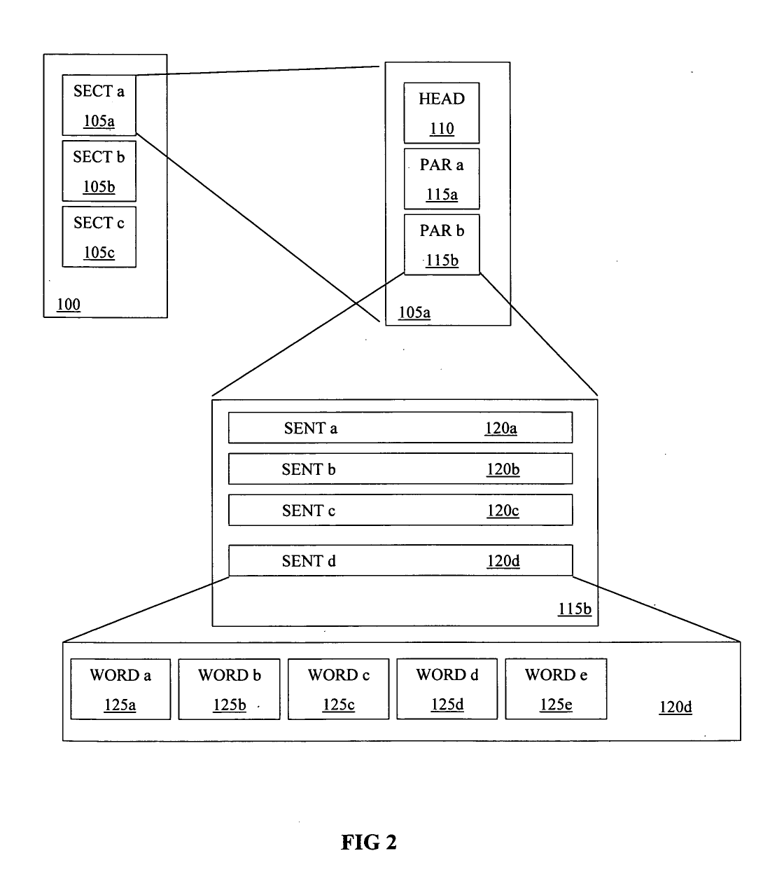

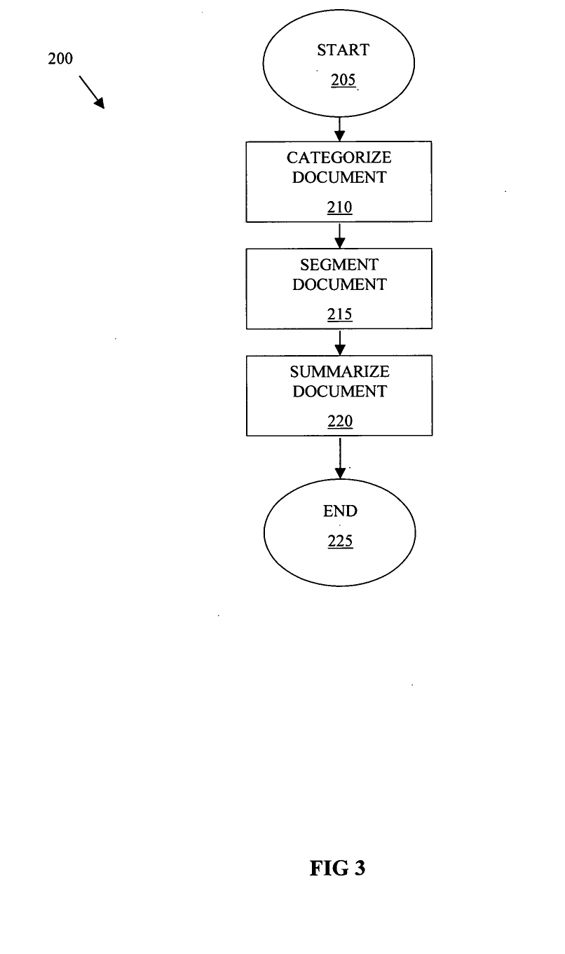

An example of such a method is illustrates in FIG. 3 and generally designated by the reference numeral 200. FIG. 2 illustrates an example of a document 100 that may be summarized using the method 200. For example, the document 100 is a legal document such as a court judgment.

The document 100 includes sections 105a, 105b and 105c. Each of the sections 105a, 105b and 105c includes a section heading and paragraphs. For example, as seen in FIG. 2, the paragraph 105a includes a section heading 110 and two paragraphs 115a and 115b. In turn, each of the paragraphs 115a and 115b includes sentences. For example, the paragraph 115b includes four sentences, namely sentences 120a, 120b, 120c and 120d. Finally, each of the sentences 120a, 120b, 120c and 120d includes words such as, for example, words 125a, 125b, 125c, 125d and 125e of the sentence 120d. The reader skilled in the art will readily appreciate that the document 100 illustrated in FIG. 2 is shown for example purposes only and that the method 200 may be used to summarize any suitable document.

The document 100 is segmentable into a plurality of text segments. Each text segment includes at least one of the words. Also, the document 100 is classifiable as belonging to a category selected from a set of predetermined categories and each text segment is classifiable as belonging to a theme selected from a set of predetermined themes.

Generally speaking, the method 200 involves the use of a priori information regarding the structure of the document 100. This a priori information is used to produce the document summary.

More specifically, the method 200 starts at step 205. At step 210, the document 100 is associated with a specific category from a set of predetermined categories. At set 215, the document is segmented and, afterwards, at step 220, the document is summarized. Finally, the method ends at step 225. The segmentation performed at step 215 is a thematic segmentation and is dependent on the category to which the document is associated. Also, step 220 of summarizing the document is performed segment-by-segment and textual units, such as for example paragraphs, sentences or words, from each segment are selected for inclusion into the summary depending on the theme to which the text segment is associated. The a priori information regarding the document is embedded into the specific manner in which the document is categorized, segmented and summarized.

By using this a priori information, it is possible to produce accurate summaries of a wide variety of documents belonging to a general document type such as, for example, court judgments. The reader skilled in the art will readily appreciate that while examples given herein regarding the method 200 refer to a court judgment, the proposed method is applicable to any other suitable documents.

At step 210, a specific category from the set of predetermined categories is associated with the document 100. For example, in the case of a judgment, the predetermined category associated with a specific document may be “immigration case relating to acceptance or refusal of the grant of a refugee status”. In some embodiments of the invention, the predetermined categories are organized according to a hierarchy, such as is often the case in many fields such as, for example, in the legal field. Typically, but in no manner exclusively, the predetermined categories are categories that are commonly used in the field to which the document 100 relates.

While any suitable method may be used to categorize the document 100 into a specific category, it has been found that a combination of heuristic rules and statistical methods allows to relatively effectively classify legal documents. More specifically, in a specific embodiment of the invention, associating the document 100 with a specific category includes computing for each category from the set of predetermined categories a respective document categorization score indicative of a likelihood that the document is classifiable in each category. The document categorization score is computed from the document.

The specific category to be associated with the document 100 is a category from the set of predetermined categories for which a document categorization score associated therewith is maximal. In a specific embodiment of the invention, computing the document categorization scores includes computing a categorization statistical score by computing a document statistic of the document 100 and comparing the document statistic with a set of predetermined statistics, each predetermined statistic being associated with a respective predetermined category from the set of predetermined categories.

The predetermined statistics are representative of documents classifiable in the respective predetermined categories to which they are associated. In other words, the predetermined statistics are used to compare the statistics of the document 100 to predetermined statistics that are known to represent text classifiable in the predetermined categories. For example, the predetermined statistics have been obtained by computing the statistic for documents that have been manually classified by a human. Once these predetermined statistics have been computed for a sample, they are used without any change to classify new documents. In other embodiments of the invention, when an error is detected in the classification made by the method 200, the predetermined statistics are updated according to a rightful classification of the document 100 determined by a human user. An example of a suitable statistic usable with the method 200 is a document statistic obtained using a support vector machine method. This method is well known in the art and will therefore not be described in further details.

In addition to using statistical methods, the categorization performed at step 210 may also use a set of predetermined heuristic rules to compute a document heuristic score. More specifically, the document categorization score may be computed by applying a set of predetermined categorization rules to the document 100. Each predetermined categorization rule, when applied to the document, results in the computation of a respective categorization rule score. The categorization rule scores are combined to each other to obtain a document categorization score.

For example, judgments including the following expressions: “infringement”, “injunctions”, “licensee” and “assessment of costs” are likely to be related to intellectual property. Therefore, the presence of these expressions in a document 100 increases a document categorization score for classification in an intellectual property category. Also, judgments including the following expressions: patent(s), NOC, Notice of Compliance, Notice of Application and Minister of Health that are known to be related to intellectual property are likely to be related to patents. Therefore, the presence of these expressions in a document 100 increases a document categorization score for classification in an intellectual property/patent category, which is a subcategory of an intellectual property category.

In a variant, a number, which may be positive or negative, is obtained by applying each rule to the document 100. For example, the presence of certain words may raise the document categorization score associated with a certain category but lower the categorization score associated with another category. The document categorization scores are afterwards combined, eventually with the document statistical score, to obtain a document categorization score representing the likelihood that the document 100 belongs to each of the predetermined categories. Afterwards, selecting the highest categorization score allows to determine which category the document should be classified into.

At step 215, the document 100 is divided into a plurality of text segments. In some embodiment of the invention, the text segments correspond to sections 105a, 105b and 105c or to paragraphs 115a and 115b. In yet other embodiments of the invention, the text segments correspond to sentences 120a to 120d or to words 125a to 125e. In yet other embodiments of the invention, the text segments correspond to any other suitable segments of the document 100. In a specific embodiment of the invention that has been found to be particularly suitable for the summarization of judgments, the text segments include contiguous paragraphs belonging to the same theme.

For example, in the context of court judgment categorization, these themes may includes the themes “decision data”, which includes the reference for the judgment and information related to the parties involved, “introduction”, which states the persons involved in the judgment and the subject matter to be resolved, “context”, which states the facts and events that led to a lawsuit to be filed, “submission”, which presents the arguments of each party relating to each issue, “issues”, which identifies the questions of law addressed by the court, “judicial analysis”, which state the reasoning and jurisprudence used by the judge to arrive to his conclusion and “conclusion”, which expresses the final decision of the court.

It should be noted that in this specific example, all segments are not necessarily used during the summarization step of the method 200. For example, the “submission” theme is relatively unimportant in some context and may therefore be completely ignored at the summarization step. However, segmenting this theme separately from the other themes allows to relatively easily distinguish this text than is ignored at the summarization step.

Also, in this example, another theme that is particularly useful is the “issues” theme. Indeed, once the issues have been identified, looking for the sections of text that address these issues at the summarization step is facilitated. For example, it is expected that all the issues identified should be addressed in the document 100, which helps in producing an accurate document summary by implementing the summarization step such that as many issues are included in the summary as the number of issues found in the “issues” theme.

In a variant, associating each text segment from the plurality of text segments to one of the themes selected from the set of predetermined themes includes computing for each text segment from the plurality of text segments a set of segment categorization scores. Each segment categorization score from the set of segment categorization scores is associated with a respective theme from the set of predetermined themes and is indicative of the likelihood that the text segments is classifiable in the theme. In these embodiments, each text segment is associated with a theme from the set of predetermined themes for which the segment categorization score associated therewith is maximal.

In some embodiments of the invention, computing the segment categorization score includes computing a segment statistic of the text segment and comparing the segment statistic with a set of predetermined segment statistics. The predetermined segment statistics are associated each with a respective predetermined theme from the set of predetermined themes and representative of segments that are classified in their respective predetermined themes for documents classified in the specific category into which the document 100 is classified. The predetermined segment statistics are obtained from documents that have been manually segmented by humans and for which the statistic has been computed. The predetermined segment statistics may be computed and fixed or otherwise iteratively corrected when the method 200 is applied to many documents.

For example, the segment statistics depend on at least one factor selected from: a section in which the paragraph included in the text segment is found, a position of the paragraph in the document, a presence of a predetermined group of words in the paragraph, and linguistic information derived from words included in the paragraph.

Also, heuristic rules may be also involved to produce scores that may be combined to the computed statistics to segment the document, in a manner similar to the manner in which categorization scores are computed to classify the document 100. For example, these heuristic rules may include rules regarding the position of paragraphs in the document 100 or theme, linguistic rules and rules based on specific knowledge of the field to which the document 100 relates.

At step 220, the segmented document 100 is summarized. For example, the document summary may be produced by selecting sentences from the document 100 to be included in the document summary. To this effect, in some embodiments of the invention, a respective sentence score indicative of a likelihood that a sentence is important in summarizing the document is computed for each sentence in the document, and the sentences having the highest sentence score are selected for inclusion in the summary.

For example, computing the sentence scores includes computing a sentence statistic of each of the sentences of the document. For example, the sentence statistic depends on at least one factor selected from: the position of the sentence in the document, a position of a paragraph in which a sentence is included in the section in which the paragraph is included, a frequency of words or textual units includes in the sentence compared to a frequency with which the words or textual units are includes in the document, an expected frequency with which the words or textual units included in the sentence are expected to be included in documents categorized in the specific category and in themes associated with the paragraph in which the sentence is included, among other possibilities.

Also, in some embodiments of the invention, computing the sentence score includes computing a heuristic sentence score from the sentence by applying the set of predetermined heuristic sentence rules to the sentence, each heuristic sentence rule being associated with the sentence rules score. Afterwards, the sentence rules scores are combined to obtain a heuristic sentence score, for example by adding the sentence rule scores to each other.

A non-limiting example of a sentence rule is as follows. If the document 100 is known to be in an Immigration/Refugee/Abandonment category, and a “context” theme is summarized, sentences including the following textual units increase-the sentence score of sentences in which they are found: “Abandon . . . claim”, “Claim/application . . . abandoned”, “Abandonment . . . hearing”.

Finally, the heuristic sentence score and the sentence statistic are combined to obtain a sentence score, which is used to select sentences for inclusion into the summary. In some embodiments of the invention, the document is summarized by including sentences having a score higher than a threshold score. For example, the threshold score is a predetermined score. In alternative embodiments of the invention, the threshold score is adjusted on a document-by-document basis so that the summary document has a length that is smaller than a predetermined size, as measured using any suitable document length measurement.

For example, the predetermined size is a fixed percentage of the size of the document to be summarized. It has been found that a percentage of from about 5 to15 percents, and in some embodiments about 10 percents, gives good results in summarizing legal documents, such as judgments. In other embodiments of the invention, the document summary has a predetermined size, such as for example a size enabling to print the document summary in a predetermined font onto a single page.

In some embodiments of the invention, threshold scores are selected individually for each of the predetermined themes so that sentences selected to be part of the document summary for each theme represent a predetermined fraction of the document summary. For example, it has been found that a specific repartition of the length of each theme within the summary according to the following reparation provides advantageously concise and accurate summaries: Introduction: 10% of summary; Context: 25% of summary; Juridical Analysis: 60% of summary and Conclusion: 5% of summary.

In some embodiments of the invention, the step 220 of summarizing the document includes filtering the document 100 to remove words satisfying a predetermined word rejection criterion prior to computing the sentence scores. For example, quotations of other judgments are typically relatively unimportant in producing summaries as they merely repeat extracts from other judgments. Therefore, formatting and linguistic information may be used to form filtering rules that recognize automatically such quotations.

In some embodiments of the invention, the document summary is translated into a language different from the language in which it has been produced. For example, the translation may be performed using translation rules that are dependent on the specific category into which document 100 is classified. Also, the translation rules may depend on the specific themes in which each sentence present in the summary document has been classified previously. Also, in some embodiments of the invention, the program element 300 is able to process documents written in more than one language, such that the summarization process occurs in the language in which the document has been written.

In some embodiments of the invention, the document summary is generated only by summarizing segments classified as introductory segments. For example, the introduction segment is summarized by removing secondary information from this introduction segment, such as for example and non-limitingly, dates, names of parties, information between parenthesis or brackets, and subordinate clauses. In alternative embodiments of the invention, the document summary is generated by researching predetermined expressions in the segmented document and extracting sentences including these expressions to form the document summary. For example, at least some of these expressions are associated with at least one of the themes. It is also within the scope of the invention to combine any number of the above-described summarization methods to produce the document summary. In yet other embodiments of the invention, the specific category with which the document 100 is associated may influence the segments used to produce the summary document. For example, in an immigration judgment, there is typically an error of law that the judgment addresses. This information is relatively important and may therefore be searched for in the document 100 for inclusion in the document summary.

FIG. 4 illustrates a program element 300 implementing the method 200. The program 300 includes an input module 310 for receiving the document 100. In some embodiments of the invention, the input module 310 performs a language recognition to recognize the language in which the document 100 is written. The input module 310 then transfers the document 100 to a categorization module 315 that broadly implements step 205 of categorizing the document 100. The categorized document is then sent to a segmenting module 320 that broadly segments the document as described hereinabove with respect to step 215. Afterwards, the segmented document is sent to a summarization module 325 that summarizes the document 100 according to the method detailed hereinabove with respect to step 220. Finally, the program element 300 includes an output module 330 for outputting the document summary.

In some embodiments of the invention, the document summary is added to a summary database 335 of document summaries. In some embodiments of the invention, the output module also translates the document summary in one or more languages different from the language in which the document 100 is written. In these embodiments, the document summaries are stored in multiple copies in the summary database, each copy corresponding to a different language. In these embodiments, each of the document summaries, for example document summaries 1 and 2 336A and 337A are each associated with a respective translated document summary 1 and 2 336B and 337B.

The summary database 335 is searchable using a search engine 340. For example, the search engine 340 is operative for searching the summary database 335 in all the languages in which the output module 330 outputs document summaries. Therefore, documents that were originally in any of these languages may be searched using any specific one of the languages. This approach typically produces better search results than conventional search engines that would translate a query into many languages prior to doing the search. Indeed, the output module 330 uses a priori knowledge concerning the document 100 to translate the summaries, such as for example the category into which the document 100 is classified. This allows to typically produce more accurate translated document summaries than would be possible without using this approach.

Examples of specific manners of implementing details of the above-described method are found in the following documents, which are hereby incorporated by reference in their entirety:
Atefeh Farzindar, Frédérik Rozon and Guy Lapalme. CATS a topic-oriented multi-document summarization system. DUC2005 Workshop, p. 8 Vancouver, October 2005 NIST.
Atefeh Farzindar. Automatic summarization of legal texts, Ph.D. Thesis, University of Montreal and University of Paris IV-Sorbonne, March 2005.
Atefeh FARZINDAR and Guy LAPALME, <<LetSUM, an automatic Legal Text Summarizing System>>, In Thomas F. Gordon (editors), Legal Knowledge and Information Systems, Jurix 2004: the Sevententh Annual Conference, p. 11-18, IOS Press, Berlin, December 2004.
Atefeh FARZINDAR and Guy LAPALME, <<LetSUM, a Text Summarization System in Law Field>>, THE FACE OF TEXT conference (Computer Assisted Text Analysis in the Humanities), p. 27-36, McMaster University, Hamilton, Ontario, Canada, November 2004.
Atefeh FARZINDAR and Guy LAPALME, <<The use of thematic structure and concept identification for legal text summarization>>, Computational Linguistics in the North-East (CLiNE 2004), p. 67-71, Montréal, Québec, Canada, August 2004.
Atefeh FARZINDAR and Guy LAPALME, <<Legal texts summarization by exploration of the thematic structures and argumentative roles.>> ext Summarization Branches Out Conference held in conjunction with ACL04 Text Summarization Branches Out, Barcelona, Spain, July 2004.
Atefeh FARZINDAR and Guy LAPALME, <<Using Background Information for Multi-document Summarization and Summaries in Response to a Question>>, HLT-NAACL 2003 Workshop on Text Summarization, Edmonton, Canada.

Although the present invention has been described hereinabove by way of preferred embodiments thereof, it can be modified, without departing from the spirit and nature of the subject invention as defined in the appended claims.

What is claimed is:

1. A method for producing a document summary from a document, said document including a plurality of words and being segmentable into a plurality of text segments, each text segment including at least one word, said document being classifiable as belonging to a category selected from a set of predetermined categories and each text segment being classifiable as belonging to a theme selected from a set of predetermined themes, said method comprising:
associating with said document a specific category from said set of predetermined categories;
performing a thematic segmentation of said document to produce a segmented document, said segmented document including said plurality of text segments;
associating with each text segment from said plurality of text segments a theme selected from said set of predetermined themes; and
summarizing said segmented document to produce said document summary by processing each text segment from said plurality of text segments to either
select at least one summary textual unit from said text segment, said at least on summary textual unit including at least one of said word, said at least one summary textual unit being a textual unit considered important in summarizing said document; or
extract no textual unit from said text segment;
said summary textual units being used to form said document summary;
wherein said thematic segmentation is dependent on said category to which said document is associated and said summary textual units are selected for each text segment depending on said theme with which said text segment is associated.

2. A method as defined in claim 1, wherein associating said document with a specific category includes computing for each category from said set of predetermined categories a respective document categorization score indicative of a likelihood that said document is classifiable in said category, said document categorization score being computed from said document, said specific category being a category from said set of predetermined categories for which said document categorization score associated therewith is maximal.

3. A method as defined in claim 2, wherein computing said document categorization scores includes computing a document statistic of said document and comparing said document statistic with a set of predetermined statistics, each predetermined statistic being
associated with a respective predetermined category from said set of predetermined category; and
representative of documents that are classifiable in said respective predetermined category.

4. A method as defined in claim 3, wherein said document statistic is obtained using a support vector machine method.

5. A method as defined in claim 2, wherein computing said document categorization scores includes
applying a set of predetermined categorization rules to said document, the application of each predetermined categorization rule to said document resulting in the computation of a respective categorization rule score; and
combining said categorization rule scores to obtain said document categorization scores.

6. A method as defined in claim 2, wherein computing said document categorization scores includes combining a statistical score and a heuristic score, each of said statistical and heuristic scores being computed from said document.

7. A method as defined in claim 2, wherein said set of predetermined categories is a hierarchical set of categories.

8. A method as defined in claim 1, further comprising dividing said document into said plurality of text segments.

9. A method as defined in claim 8, wherein associating with each text segment from said plurality of text segments said theme selected from said set of predetermined themes includes computing for each text segment from said plurality of text segments a set of segment categorization scores, each segment categorization score from said set of segment categorization scores being associated with a respective theme from said set of predetermined themes and being indicative of a likelihood that said text segment is classifiable in said theme with which said segment categorization score is associated, each of said text segment being associated with a theme from said set of predetermined themes for which said segment categorization score associated therewith is maximal.

10. A method as defined in claim 9, wherein computing said segment categorization scores includes computing a segment statistic of said text segment and comparing said segment statistic with a set of predetermined segment statistics, each predetermined segment statistic being
associated with a respective predetermined theme from said set of predetermined themes; and
representative of segments that are classified in said respective predetermined theme for document classified in said specific category.

11. A method as defined in claim 10, wherein
said document includes at least one section identified by a section heading present in said document, each of said sections including at least one paragraph, each of said paragraphs including at least one sentence, each of said sentences including at least one word;
each of said text segment includes at least one paragraph;
each of said segment statistic depends on a least one factor from the set consisting of: a section in which said at least one paragraph is included, a position of said at least one paragraph in said document, a presence of a predetermined group of words in said at least one paragraph and linguistic information derived from words included in said at least one paragraph included in said text segment.

12. A method as defined in claim 1, wherein
said document includes at least one section identified by a section heading present in said document, each of said sections including at least one paragraph, each of said paragraphs including at least one sentence, each of said sentences including at least one word;
summarizing said segmented document to produce said document summary includes computing for each sentence of said document a respective sentence score indicative of a likelihood that said sentence is important in summarizing said document.

13. A method as defined in claim 12, wherein computing said sentence scores for each sentence includes computing a sentence statistic of said sentence.

14. A method as defined in claim 13, wherein said sentence statistic depends on at least one factor selected from the set consisting of: a position of said sentence in said document, a position of a paragraph in which said sentence is included in said section in which said paragraph is included; a frequency of words included in said sentence as compared with a frequency with which said words are included in said document, an expected frequency with which said words included in said sentence are expected to be included in documents categorized in said specific category and in themes associated with said paragraph in which said sentence is included, a frequency of textual units included in said sentence as compared with a frequency with which said textual units are included in said document, and an expected frequency with which textual units included in said sentence are expected to be included in documents categorized in said specific category and in themes associated with said paragraph in which said sentence is included.

15. A method as defined in claim 14, wherein computing said sentence score includes, for each sentence,
computing a heuristic sentence score from said sentence by applying a set of predetermined heuristic sentence rules to said sentence, each heuristic sentence rule being associated with a sentence rule score;
combining said sentence rule scores to obtain said heuristic sentence score; and
combining said heuristic sentence score and said sentence statistic to obtain said sentence score.

16. A method as defined in claim 15, wherein said document summary includes sentences from said document having a sentence score higher than a threshold score, said threshold score being selected so that said summary document is smaller than a predetermined size.

17. A method as defined in claim 16, wherein said threshold score is selected individually for each of said predetermined themes so that said sentences selected to be part of said document summary for each of said predetermined themes represent a predetermined fraction of said document.

18. A method as defined in claim 1, further comprising filtering said document to remove words satisfying a predetermined word rejection criterion.

19. A method as defined in claim 1, wherein summarizing said document includes replacing in said document expressions included in a list of predetermined expressions by respective predetermined abbreviations.

20. A method as defined in claim 1, further comprising translating said document summary.

21. A method as defined in claim 20, wherein translating said document is performed using translation rules which depend on said specific category.

22. A method as defined in claim 1, wherein said document is a court judgment.

23. A computer readable storage medium containing a program element for execution by a computing device, said program element being able to produce a document summary from a document, said document including a plurality of words and being segmentable into a plurality of text segments, each text segment including at least one word, said document being classifiable as belonging to a category selected from a set of predetermined categories and each text segment being classifiable as belonging to a theme selected from a set of predetermined themes, said program element comprising:
an input module operative for receiving the document;
a categorization module operative for associating with said document a specific category from said set of predetermined categories;
a segmentation module operative for
performing a thematic segmentation of said document to produce a segmented document, said segmented document including said plurality of text segments; and
associating with each text segment from said plurality of text segments a theme selected from said set of predetermined themes;
a summarization module operative for summarizing said segmented document to produce said document summary by processing each text segment from said plurality of text segments to either
select at least one summary textual unit from said text segment, said at least on summary textual unit including at least one of said word, said at least one summary textual unit being a textual unit considered important in summarizing said document; or
extract no textual unit from said text segment;
said summary textual units being used to form said document summary; and
an output module operative for releasing the summarized document;
wherein said thematic segmentation is dependent on said category to which said document is associated and said summary textual units are selected for each text segment depending on said theme with which said text segment is associated.
